(19) United States
(12) Patent Application Publication
(10) Pub. No.: US 2013/0076530 A1
(43) Pub. Date: Mar. 28, 2013

(54) Portable device environmental monitoring apparatus and method

(71) Applicant: William Peter Heckel, III, Dallas, TX (US)

(72) Inventor: William Peter Heckel, III, Dallas, TX (US)

(21) Appl. No.: 13/614,810

(22) Filed: Sep. 13, 2012

Related U.S. Application Data
(60) Provisional application No. 61/534,278, filed on Sep. 13, 2011.

(51) Int. Cl. G08C 19/00

(52) U.S. Cl. CPC G08C 19/00
USPC 340/870.02

(57) ABSTRACT

An independent internal monitoring system for the environmental conditions to which a portable electronic device is subjected including non-volatile memory and short term power loss protection.

### CROSS REFERENCE TO RELATED APPLICATIONS

This application claims the benefit of PPA: US 61/534,278 filed 2011 Sep. 13 by the present inventor, which is incorporated by reference.

### FIELD OF THE INVENTION

The invention is in the technical field of portable electronic devices. More particularly, the invention is in the technical field of environmental monitoring of portable electronic devices.

### BACKGROUND OF THE INVENTION

Portable electronic devices such as mobile telephones, cameras and multimedia devices are being reduced in size and increasing in functionality. Many consumers carry these devices in their pockets or purses and handle them fairly often while distracted. These factors lead to a greater likelihood of drop, impact or environmental damage which may not be obvious on the exterior of the device. Operation outside of the designed environment and rough handling may cause failures. Currently a manufacturer or operator has no reliable system for monitoring the usage of their portable electronic devices with regards to environment, drops, falls and impacts. In many cases the manufacturer or an independent third party accepts liability for the nominal operation of the device through a warranty or guaranty for a set time period. In the case of portable electronic devices, the manufacturer has no means of controlling or monitoring the usage with regards to careful handling.

U.S. Pat. No. 5,056,056 discloses a battery powered data recorder employing a recirculating memory for crash event recording.

U.S. Pat. No. 6,894,606 discloses a vehicular warning system that monitors operational parameters prior to an incident may be retrieval after an incident.

U.S. Pat. No. 7,827,420 discloses a portable device has been equipped with automatic power-off protection upon sensing that a particular acceleration threshold has been exceeded.

These systems, while somewhat useful for their particular intended applications do not provide for reliable, continuous and or statistical monitoring of operational conditions.

### SUMMARY OF THE INVENTION

The invention is an abuse, misuse and environment monitoring device for portable electronic devices. This device monitors the forces acting on it using accelerometers and or other environmental sensors to determine when the device has been subjected to a possible misuse or abuse situation. It uses electronics and non-volatile memory to monitor and record these events. These recorded events may be recovered and analyzed for reliability and maintenance purposes. In the event that the portable electronic device which includes the invention is rendered unusable the recorded events may be recovered for analysis.

### BRIEF DESCRIPTION OF THE DRAWINGS

FIG. 1 is a block diagram of one embodiment of the invention;

FIG. 2 is a block diagram of an alternative embodiment of the invention; and

FIG. 3 is a block diagram of an alternative embodiment of the invention; and

FIG. 4 is a block diagram of an alternative embodiment of the invention; and

FIG. 5 is a flow chart showing background software operation

### DETAILED DESCRIPTION OF THE INVENTION

The invention combines an accelerometer and or other environmental sensors, a microprocessor, non-volatile memory and a temporary power storage means with a method of detecting, qualifying and storing environmental data which could be of significance to the portable electronic device's reliability. The gathered data may be used to improve the device reliability by gathering real world usage statistics. The gathered data may also be used to determine the cause of failure. Furthermore, the invention is capable of operating independently of the portable electronic device's main CPU and includes the ability to withstand brief power interruptions while continuing to record data.

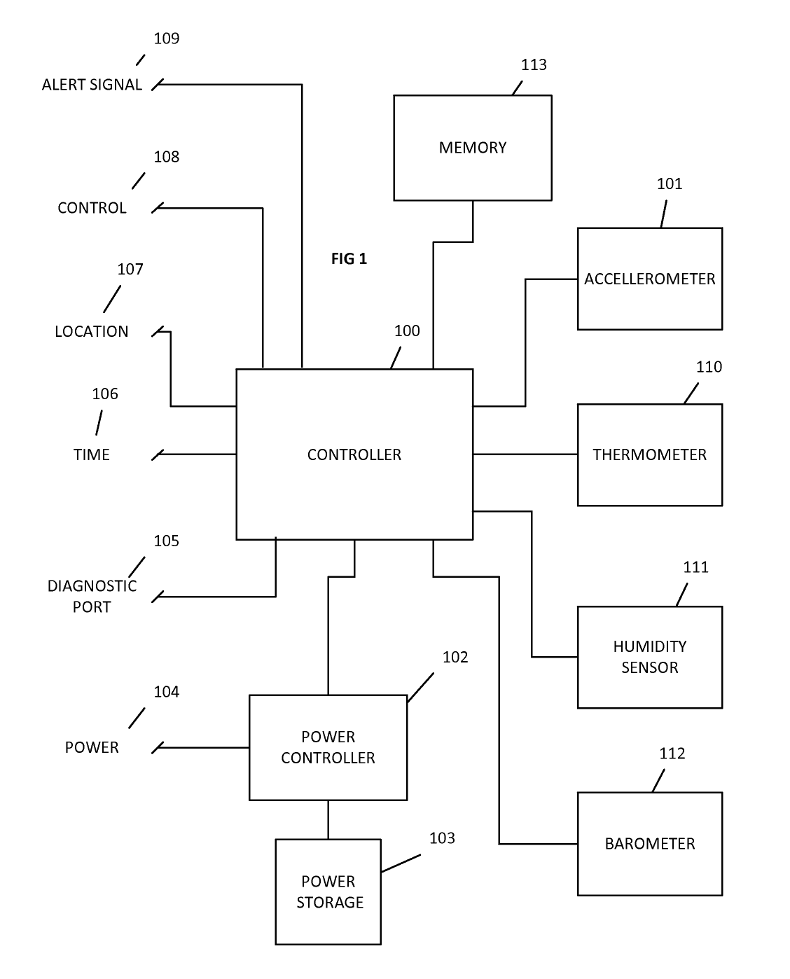

Referring now to the invention in more detail, in FIG. 1 there is shown a block diagram of the invention. ACCELEROMETER 101 detects gravitational and inertial forces and transmits them to microprocessor CONTROLLER 100. THERMOMETER 110 measures and transmits the environmental temperature measured to CONTROLLER 100. HUMIDITY SENSOR 111 senses the relative humidity and transmits the sensed humidity conditions to CONTROLLER 100. BAROMETER 112 senses and transmits the local environmental pressure to CONTROLLER 100. Local TIME 106 and current LOCATION 107 is transmitted from the portable device to CONTROLLER 100. Portable device battery condition is sensed by the POWER CONTROLLER 102 and transmitted to CONTROLLER 100. The microprocessor CONTROLLER 100 executes a software program which determines if the environmental event data needs to be recorded in external non-volatile MEMORY 113 and records same if it meets the predetermined criteria. If the conditions require a user notification an ALERT SIGNAL 109 is sent from CONTROLLER 100 to the portable device. The portable electronic device's CPU may send signals to retrieve the event and environmental data from the non-volatile MEMORY 113 via the data connection labeled CONTROL 108. If the portable device is damaged the event data may be retrieved from non-volatile MEMORY 113 via the DIAGNOSTIC PORT 105. In the event of a POWER 104 loss from the main battery the POWER CONTROLLER 102 will draw power from POWER STORAGE 103 to continue operating the CONTROLLER 100 and other components as needed so that the environmental conditions are recorded. Under normal operation the POWER STORAGE 103 is charged by the POWER CONTROLLER 102 using the portable device's POWER 104.

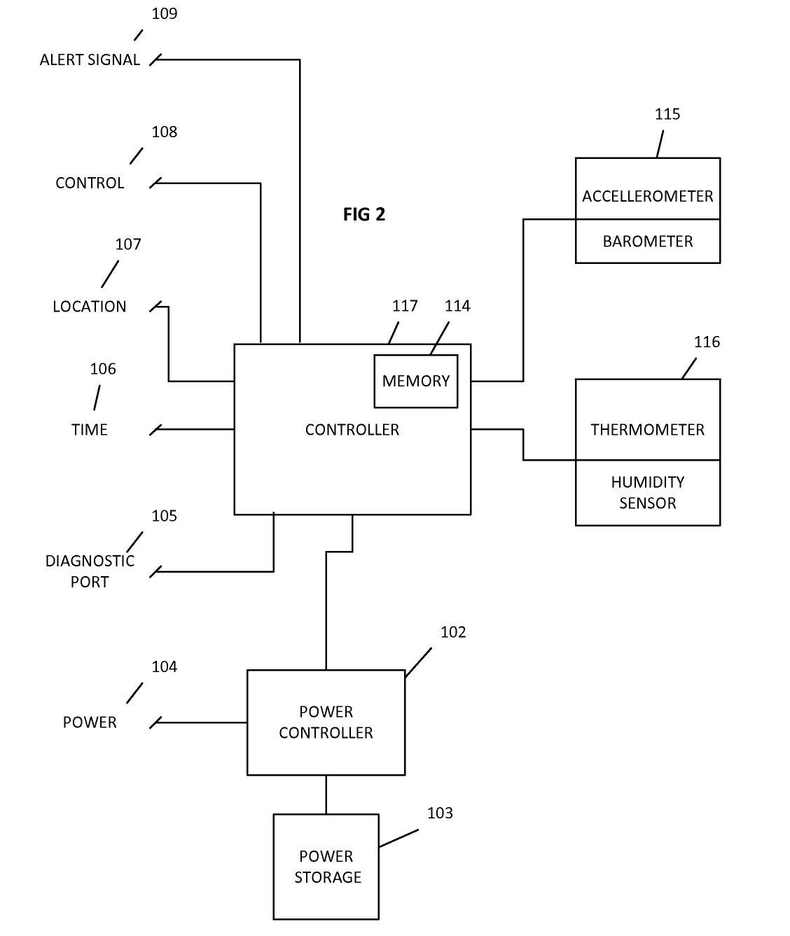

Referring now to the invention in more detail, in FIG. 2 there is shown a block diagram of the invention. Combined ACCELEROMETER and BAROMETER 115 measures gravitational and inertial forces as well as barometric pressure and transmits them to CONTROLLER 117 with integrated non-volatile MEMORY 114. Combined THERMOMETER and BAROMETER 116 measures and transmits the temperature and relative humidity to CONTROLLER 117. Local TIME 106 and current LOCATION 107 is transmitted from the portable device to CONTROLLER 117. Portable device battery condition is sensed by the POWER CONTROLLER 102 and transmitted to CONTROLLER 117. The microprocessor CONTROLLER 117 executes an internal program which determines if the environmental event data needs to be recorded in internal non-volatile MEMORY 114 and records same if it meets the predetermined criteria. If the conditions require a user notification an ALERT SIGNAL 109 is sent from CONTROLLER 117 to the portable device. The portable electronic device's CPU may send signals to retrieve the event and environmental data from the non-volatile MEMORY 113 via the data connection labeled CONTROL 108. If the portable device is damaged the event data may be retrieved from non-volatile MEMORY 114 via the DIAGNOSTIC PORT 105. In the event of a POWER 104 loss from the main battery the POWER CONTROLLER 102 will draw power from POWER STORAGE 103 to continue operating the CONTROLLER 117 so that the environmental conditions are recorded. Under normal operation the POWER STORAGE 103 is charged by the POWER CONTROLLER 102 using the portable device's POWER 104.

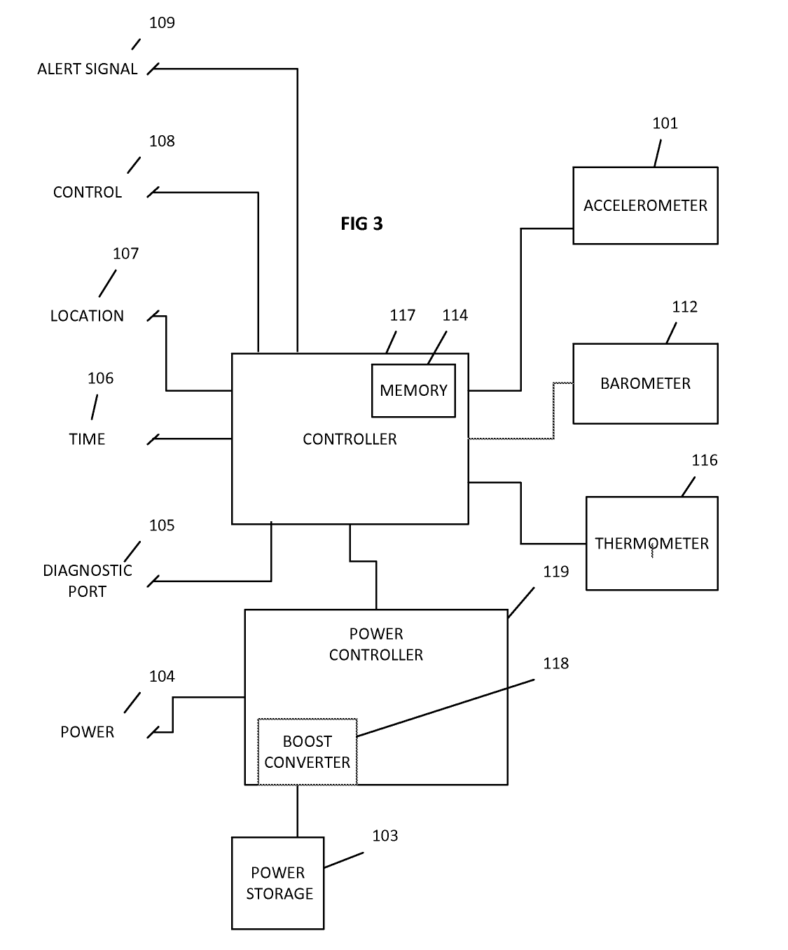

Referring to one specific embodiment of the invention, there is shown in FIG. 3 an ACCELEROMETER 120 which is an Analog Devices Model ADXL346 device with digital output providing acceleration sensing capability and fall triggering along with a memory buffer, a Microprocessor CONTROLLER 121 which is a Texas Instruments model MPS430 low power integrated microcontroller with internal ferroelectric MEMORY 122. A BAROMETER 123 which is an ST Microelectronics LPS001WP MEMS sensor with digital output. Each of the sensor modules, ACCELEROMETER 120, BAROMETER 123 AND THERMOMETER 124 may be powered down to reduce energy consumption in the case of POWER 104 failure. The POWER CONTROLLER 119 circuit includes a BOOST CONVERTER 118 to allow better utilization of the energy stored in the POWER STORAGE 125 which is a 6.3 volt 470 uF ultra-low leakage tantalum capacitor. Communication with the portable electronic device's CPU is via CONTROL AND DATA 126 which provides the CONTROLLER 121 the means to request and supply data including time, location and environmental conditions as well as communicate the portable device's power status. ALERT SIGNAL 109 is connected to an interrupt line on the portable device's CPU allowing the CONTROLLER 121 to interrupt the host when a programmed condition is detected.

The invention shown includes a POWER CONTROLLER 102 and 119 in FIGS. 1 and 3 respectively. It is understood that minimizing the power consumption of the entire environmental monitoring system is an important feature. In addition, maximizing the available energy recoverable from the POWER STORAGE 103 and 125 is critical to minimizing the volume of the entire system. This may be accomplished using a variety of means including but not limited to boost/buck power supply circuits, low resistance pass transistors and high efficiency capacitors or rechargeable batteries in a myriad of configurations. The shown configuration is but one of many possible and is not meant to be limiting in any way.

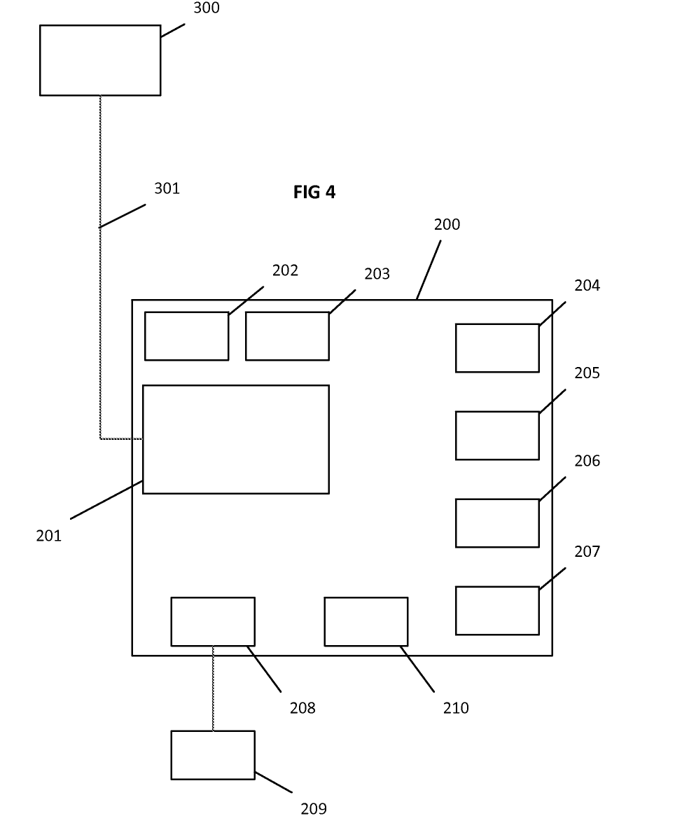

Referring now to the invention in more detail, in FIG. 4 there is shown a block diagram of the invention. The integrated MONITORING SYSTEM 200 is largely contained in a single semiconductor package on one or more die made from silicon or other suitable material. The MICROPROCESSOR 201, OPERATING MEMORY 202, ferroelectric non-volatile MEMORY 203, ACCELEROMETER 204, BAROMETER 205, TEMPERATURE SENSOR 206, relative HUMIDITY SENSOR 207, POWER CONTROLLER 208, and MANAGEMENT LOGIC 210 are all integrated into a single device. Temporary POWER STORAGE 209 is a separate capacitor or battery and may include an inductor as needed for the efficient utilization of the stored charge. Communication with the HOST PROCESSOR 300 is provided by a SERIAL CONNECTION 301 over which bidirectional communication may take place. The MANAGEMENT LOGIC 210 includes the typical analog and digital interface circuits needed in an integrated device as well as the logic features needed to control the sensors.

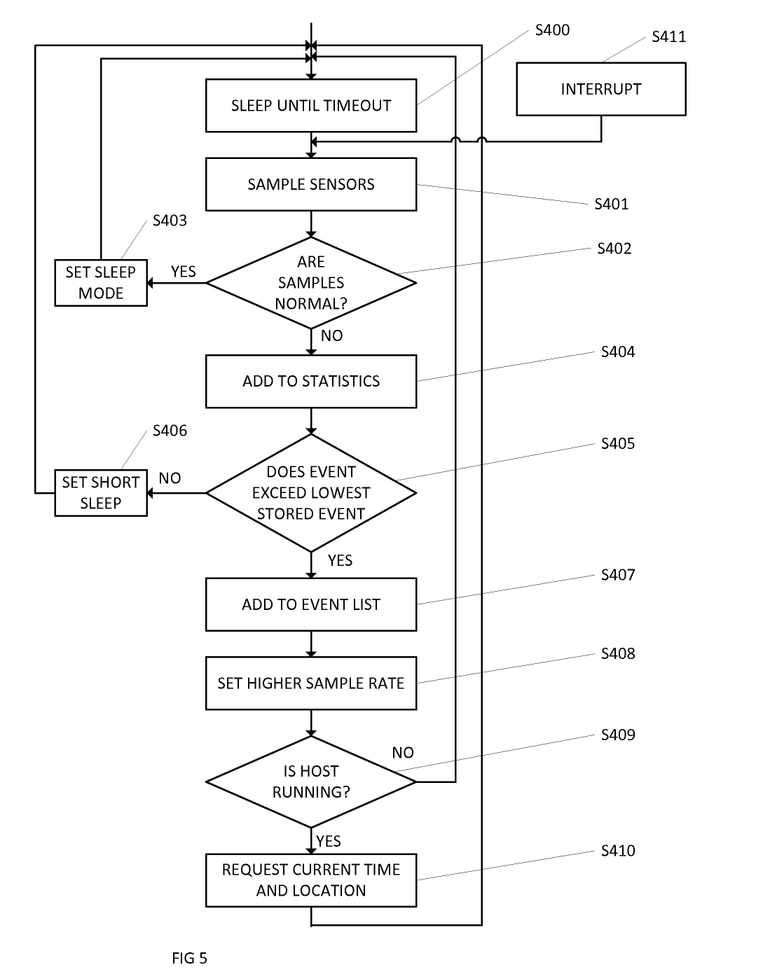

In FIG. 5 there is shown a flow chart of the normal background operation of the software running in the invention. This mode is in operation during low power modes including main device power off modes. Initialization and setup of the components and working memory are not shown. Upon initialization the system will set a timer and wait for an event to occur. If an event does not occur the timer will periodically wake the device to check for normal operating parameters. This waiting step is shown as S400. If an event occurs that exceeds the set limits on the accelerometer or other sensor capable of generating an interrupt, shown as step S411, the device will wake and sample the sensors S401. If the sensor values lie within normal operating parameters the device will reset the sleep timer and enter sleep mode S403. If the sensor values lie outside the normal operating range the event data will be added to the statistical record S404. If the event data indicates that this event is significant and exceeds the magnitude of the least important event stored in memory S405 it will be added to the event list S407, otherwise a shorter time period will be set and sleep mode will be entered S406. If the event is determined to be significant and ongoing the sample rate will be increased S408 for better resolution. If the portable device's host CPU is operating S409 it will be queried for time and location information S410. The example shown here is simplified for clarity but shows the basic low power mode of operation to be used during host power off and sleep mode situations.

A brief summary of the operation of the software in this invention follows. Upon beginning operation the internal microprocessor determines the event which led to the restart which may include performing a checksum or testing a progress value in the non-volatile memory. Depending on the reason for the restart of operation several different paths may be taken. In a cold start, the software will initialize the working memory, configure each of the sensors for their appropriate cold start mode and determine the battery level and status of the host device's system. In a warm restart mode the software will determine if the device is currently encountering a significant event and begin or continue recording data for storage. If on restart the host CPU is found to be operating the sensors will be configured to provide data as required for operation by the host system and will notify the host system upon completion of setup. Additional configuration changes to the sensors may be made at the request of the host system such as sample frequency, accuracy and transmission rate. If the host no longer needs access to the information gathered by the sensors or ceases to request the data the sensors will be configured in a mode suitable for the environmental monitoring system's needs. If, while configured for host data access, an environmental event occurs, the monitoring system may respond to the event in the normal manner. During host off normal battery level operation the sensors, particularly the accelerometer, will be configured to trigger an interrupt to the microprocessor of the invention in the event of a reading that exceeds the chosen trigger points. Once each sensor has been configured, the microprocessor will setup a wake timer and go into a low power sleep mode to wait for an event. The number of wait periods between events can be used to determine that the device has been stored or otherwise unused and increase the time periods between wakeup events to conserve power. If the battery level is determined to be low enough to cause damage to the battery if additional power is consumed the device will shut down the sensors and enter the minimum power possible mode. Before entering the shutdown mode the monitoring system may record the battery level and time of shutdown in its non-volatile memory. Upon receipt of an interrupt indicating free fall, high acceleration or other extreme conditions the microcontroller will wake and follow a path similar to that described in FIG. 5, entering at step S411. The accelerometer 120 shown in FIG. 3 includes a circular memory allowing the capture of samples prior to the condition that caused the interrupt. This data, along with the data gathered post interrupt may be used to calculate the likely distance of a drop event and may be used to construct the event record for storage in the ferroelectric memory or other non-volatile forms of memory of the invention.

The advantages of the invention include, without limitation, the ability to continuously monitor the environmental conditions of the portable electronic device without requiring operation of the host device's CPU or other components. In addition, the invention has the ability to withstand the loss of main battery power while continuing to record data for some time which can capture impact or fall events that might cause a battery bounce or detachment. Furthermore through the use of low power components such as ferroelectric non-volatile memory and efficient accelerometers the total power consumption of the invention can be minimized allowing operation during host power off periods. Additionally the invention allows for the environmental data to be retrieved from the device via a diagnostic port. This port is intended to allow operation of only the monitoring subsystem of the portable electronic device allowing forensic analysis of damaged devices. Having an embedded monitoring system within the portable device whether it is a cellular telephone, media player or handheld computer gives the users, operators and manufacturers solid data on the real world usage of their equipment. The advantages of this invention include the ability of careful users to show evidence that their use of the device did not lead to its failure and allows manufacturers to monitor the real world situations that lead to device failure. That data may allow a reduction in warranty claim costs through reliably tracking the events that led to physical damage. The statistical environmental data may further the design of more robust or lower cost devices, and may give the user information on how well or poorly they are treating their portable device relative to other users and the manufacturer's specifications. Yet another advantage conveyed by the invention is that these features may be added without duplicating existing devices in the portable device. The data measured by the accelerometers can be transmitted from the invention to the portable device's CPU for real time measurements. This data may be sent at a rapid rate for gesture based interfaces and other needs while in use by the host. In addition, using the devices specified in FIG. 3 and a typical cellular telephone battery of 1.3 amp hour capacity it should be possible to achieve continuous monitoring for over one year given no other power consumption. This inherently low power architecture allows for continuous monitoring during main system power off modes. Lower power consumption may be realized by full integration of the required devices as shown in FIG. 4. Furthermore, the inclusion of trigger levels and alert boundaries in the sensors themselves may allow the monitoring CPU to operate in idle or power down mode more often conserving power further.

In broad terms the invention is a black box for portable devices that operates within yet independently from the host system. It monitors and records one or more environmental conditions such as acceleration, temperature, humidity, pressure, rotation, radiation, sound pressure, brightness, magnetic field or battery voltage and records them in non-volatile memory. It combines the very low power consumption ferroelectric non-volatile memory with innovative power management and efficient sensors to produce a monitoring system capable of continuous monitoring using very little power.

While the above written description of the invention enables one of ordinary skill to make and use what is considered presently to be the best mode of the invention, those of ordinary skill will understand and appreciate the existence of variations, combinations, and equivalents of the specific embodiment, method, and examples herein. The invention should therefore not be limited by the above described specific embodiments, methods, and examples, but by all embodiments and methods within the scope and spirit of the invention.

The invention claimed is:

1. An environmental monitoring system for inclusion within a host portable device that is capable of recording the environmental conditions within which the portable device is operating.

2. The environmental monitoring system of claim 1 wherein said environmental monitoring system includes an independent power storage system charged from the portable device's power supply.

3. The environmental monitoring system of claim 2 wherein said independent power storage system includes a short term storage element and a boost convertor to make full use of the stored energy during a host system power failure.

4. The environmental monitoring system of claim 1 wherein said environmental monitoring system is fully independent of the host portable device's processing and storage systems

5. The environmental monitoring system of claim 1 wherein said system includes an independent microprocessor utilizing ferroelectric memory for non-volatile storage of said environmental conditions.

6. The environmental monitoring system of claim 1 wherein the sensors utilized are selected from the group consisting of accelerometers, barometers, thermal sensors, light sensors, angular rate sensors, humidity sensors, radiation sensors, current sensors, global positioning system receivers, clocks, microphones and magnetic field sensors.

7. The environmental monitoring system of claim 1 where the sensor readings can be read via a request from the host device.

8. The environmental monitoring system of claim 6 which shares common sensors with the host device.

9. A method of detecting and recording events and conditions that affect the operation and reliability of a portable device comprising:
a. sensors to detect the conditions under which the portable device is exposed,
b. a microprocessor to execute the steps required to determine if, based on sensor values, an event is significant,
c. nonvolatile memory to store said events,
d. an interface for retrieval of said events from said memory

10. The environmental monitoring system utilizing the methods of claim 9 which includes an interface to the host device allowing communication and configuration of the monitoring system from the host device's central processor.

11. The environmental monitoring system of claim 9 allowing the host device to read event data for presentation to the user.

12. The environmental monitoring system of claim 9 allowing the host device to read event data for presentation or transmission to the operator or manufacturer of the device using the host device's communication abilities.

13. The environmental monitoring system utilizing the methods of claim 9 which includes an interface to an external device allowing communication and recovery of stored event data with the said system independently of the host's operating condition.

14. The environmental monitoring system utilizing the methods of claim 11 in which the primary components are contained within a common package with one of the host system's integrated circuits.
